(19) United States
(12) Patent Application Publication
(10) Pub. No.: US 2021/0107549 A1
(43) Pub. Date: Apr. 15, 2021

(54) FOLDING WAGON

(71) Applicant: Eurmax Canopy Inc, El Monte, CA (US)

(72) Inventor: Weigang WANG, El Monte, CA (US)

(21) Appl. No.: 16/750,298

(22) Filed: Jan. 23, 2020

Related U.S. Application Data
(63) Continuation-in-part of application No. 16/598,831, filed on Oct. 10, 2019.

(51) Int. Cl. B62B 3/02; B62B 5/06

(52) U.S. Cl. CPC B62B 3/025; B62B 5/067

(57) ABSTRACT

A folding wagon frame has corner posts including a front right post, a front left post, a rear right post, and a rear left post. Upper corner joints include a front right upper joint on the front right post, a front left upper joint on the front left post, a rear right upper joint on the rear right post, and a rear left upper joint on the rear left post. Slide joints are slidingly mounted below the upper corner joints on the corner posts and include a front right slide joint on the front right post, a front left slide joint on the front left post, a rear right slide joint on the rear right post, and a rear left slide joint on the rear left post.

This application claims priority from and is a continuation in part of earlier filed parent utility patent application Ser. No. 16/598,831 filed Oct. 10, 2019, entitled Folding Wagon by same inventor Weigang WANG, the disclosure of which is operated herein by reference.

### FIELD OF THE INVENTION

The present invention is in the field of folding wagons.

### DISCUSSION OF RELATED ART

A variety of different folding wagon have been described in the prior art for transporting articles. For example, in the U.S. Pat. No. 8,388,015, Folding Wagon With Seats by inventor Zhaosheng Chen, published Mar. 5, 2013 the abstract discloses, “A folding wagon has a folding frame with a stowed and open position. The folding frame has a pair of front vertical supports, and a pair of rear vertical supports. A lower front horizontal support connects between the pair of front vertical supports, and a lower rear horizontal support connects between the pair of rear vertical supports. An upper front horizontal support connects between the pair of front vertical supports, and an upper rear horizontal support connects between the pair of rear vertical supports. The folding frame has supplemental links that form a frame for seats including a front seat bar extending between a pair of front seat vertical members and including a rear seat bar extending between a pair of rear seat vertical members. Sidewall members have a pair of horizontal supports pivotally connected to the front vertical supports and the rear vertical supports.”

For example, in the U.S. Pat. No. 8,973,940, Folding Wagon by inventor Zhaosheng Chen et al., published Mar. 10, 2015 the abstract discloses, “The present invention is a wagon that can be folded along a middle plane that bisects the wagon between a front and rear portion. The folding wagon comprises of wheels, a folding frame, a support structure, a front panel a handle connected to the frame, wheels, and a bag hanger that are detailed herein. The folding frame includes a top rail formed of a top rail front portion and a top rail rear portion, a middle rail formed of a middle rail front portion and a middle rail rear portion, a bottom rail formed of a bottom rail front portion and a bottom rail rear portion. The top rail, the middle rail, and the bottom rail are connected by a hinge means. The top rail front portion is mounted to the top rail rear portion.”

For example, in the U.S. Pat. No. 9,327,749, Foldable Wagon by inventor Matthew E. Young et al., published May 3, 2016 the abstract discloses, “A foldable wagon is provided having a collapsible frame that converts the wagon from a use configuration to a folded configuration for storage and transportation. The foldable wagon has a collapsible frame positonable in an open position and a collapsed position, a plurality of wheels coupled to the collapsible frame, a plurality of substantially rigid seats pivotally coupled to the collapsible frame, and a flexible housing about the collapsible frame to form a sidewall for the wagon. The substantially rigid seats each having a substantially rigid seat back and a substantially rigid seat bottom hingedly coupled to the seat back.”

For example, in the International publication number JP2016/088193, Transport Vehicle and Frame Structure by inventor Masago Takeda, published May 23, 2016 the abstract discloses, “PROBLEM TO BE SOLVED: To provide a transport vehicle that can take a folded form having excellent safety. SOLUTION: A transport vehicle 100 is equipped with a pair of front casters 101, a pair of rear casters 102, and a pair of wheels 103 which are so provided as to be mounted between the front caster 101 and the rear caster 102. The transport vehicle 100 is further equipped with: longitudinal frames 111, 112 which respectively support the front caster 101 and the rear caster 102; a support frame 113 which extends in a substantially vertical direction between the longitudinal frames 111, 112 and supports the wheel 103; and base frames 114, 115 which are rotatably constructed between each of the longitudinal frame 111, 112 and the support frame 113. The support frame 113 is equipped with an interpolation component 113a on which the wheel 103 is mounted, and an extrapolation component 113b to which base frames 114, 115 are rotatably connected and which is so extrapolated as to be slidable with respect to the interpolation component 113a.”

For example, in the U.S. Pat. No. 9,101,206, Folding Table Umbrella Wagon by inventor Zhaosheng Chen et al., published Aug. 11, 2015 the abstract discloses, “A portable folding table wagon includes a wagon with a wagon body that has a folding wagon frame and wheels connected to a lower portion of the folding wagon frame. The folding wagon frame folds to a deployed position and expands to a stowed position. The folding wagon frame forms a wagon cavity for carrying articles when the folding wagon frame is in deployed position. A table top has a table top surface configured to fit on the folding wagon frame. The portable folding table wagon may also have an umbrella with a pole. A table opening is formed on the table top surface. The table opening is configured to receive the pole. A pole retainer is formed on the folding wagon frame. The pole retainer is configured to receive the pole.” The above prior art references are incorporated herein by reference.

### SUMMARY OF THE INVENTION

A folding wagon frame has corner posts including a front right post, a front left post, a rear right post, and a rear left post. Upper corner joints include a front right upper joint on the front right post, a front left upper joint on the front left post, a rear right upper joint on the rear right post, and a rear left upper joint on the rear left post.

Slide joints are slidingly mounted below the upper corner joints on the corner posts and include a front right slide joint on the front right post, a front left slide joint on the front left post, a rear right slide joint on the rear right post, and a rear left slide joint on the rear left post.

Lower joints are mounted to the corner posts below the slide joints and include a front right lower joint on the front right post, a front left lower joint on the front left post, a rear right lower joint on the rear right post, and a rear left lower joint on the rear left post. Middle posts include a left middle post and a right middle post. The middle posts are floating as in not abutting or supported by a structure below it.

The right middle post is mounted between the front right post and the rear right post. The left middle post is mounted between the front left post and the rear left post. The right middle post has a right middle post upper joint formed at an upper end of the right middle post, and a right middle post lower joint formed at a lower end of the right middle post. The left middle post has a left middle post upper joint formed at an upper end of the left middle post, and a left middle post lower joint is formed at a lower end of the left middle post.

A pair of side panels includes a left side panel and a right side panel. The left side panel has a left side front main member that extends from the front left upper joint to the left middle post lower joint. The left side panel has a left side front secondary member pivotally connected to the front left slide joint and a left front auxiliary joint. The left front auxiliary joint pivotally connects the left side front secondary member to a left side front auxiliary member. The left side front auxiliary member is pivotally connected to the left middle post upper joint.

The left side panel has a left side rear main member pivotally connected between the left middle post lower joint and the rear left upper joint. A left side rear secondary member is pivotally connected to the rear left slide joint and to a left rear auxiliary joint. The left side rear secondary member is pivotally connected to a left side rear auxiliary member at a left rear auxiliary joint.

The right side panel has a right side front main member that extends from the front right upper joint to the right middle post lower joint. The right side panel has a right side front secondary member pivotally connected to the front right slide joint and a right front auxiliary joint. The right front auxiliary joint pivotally connects the right side front secondary member to a right side front auxiliary member. The right side front auxiliary member is pivotally connected to the right middle post upper joint.

The right side panel has a right side rear main member pivotally connected between the right middle post lower joint and the rear right upper joint. A right side rear secondary member is pivotally connected to the rear right slide joint and to a right rear auxiliary joint. The right side rear secondary member is pivotally connected to a right side rear auxiliary member at a right rear auxiliary joint. The folding wagon frame has a folded position and a deployed position.

The folding wagon frame also optionally includes a pair of front scissor panels, including a front left scissor panel and a front right scissor panel connected to each other. The pair of front scissor panels connect between the front right post and the front left post. The front right scissor panel connects to the front right upper joint and the front right slide joint, and the front left scissor panel connects to the front left upper joint and the front left slide joint.

A pair of rear scissor panels include a rear left scissor panel and a rear right scissor panel connected to each other. The pair of rear scissor panels connects between the rear right post and the rear left post. The rear right scissor panel connects to the rear right upper joint and the rear right slide joint, and the rear left scissor panel connects to the rear left upper joint and the rear left slide joint.

A base plate, and a set of base members include a front right base member, a front left base member, a rear right base member, and a rear left base member. The base plate is pivotally connected to the set of base members. The base plate has a front right plate joint pivotally connected to the front right base member. The base plate has a front left plate joint pivotally connected to the front left base member. The base plate has a rear right plate joint pivotally connected to the rear right base member, and the base plate has a rear left plate joint pivotally connected to the rear left base member. The base members abut the base plate when the base members are unfolded to the deployed position.

A handle has a handle grip and handle shaft, wherein the handle shaft is pivotally connected to a handle bracket joint, and further including a right handle member and a left handle member, wherein the right handle member is pivotally connected to the handle bracket joint and the front right lower joint, and wherein the left handle member is pivotally connected to the handle bracket joint and the front left lower joint, wherein the right handle member and the left handle member fold between a deployed horizontal configuration and a stowed vertical configuration.

### BRIEF DESCRIPTION OF THE DRAWINGS

FIG. 1 is a top rear perspective view of the present invention.

FIG. 2 is a front lower perspective view of the present invention.

FIG. 3 is a side perspective view of the present invention.

FIG. 4 is a top perspective view of the present invention.

FIG. 5 is a right side perspective view of the present invention.

FIG. 6 is a top view of the present invention.

The following call out list of elements can be a useful guide in referencing the elements of the drawings.
20 Vertical Posts
21 Front Right Post
22 Front Left Post
23 Rear Right Post
24 Rear Left Post
25 Right Middle Post
26 Left Middle Post
27 Front Right Slide Joint
28 Front Left Slide Joint
29 Rear Right Slide Joint
30 Rear Left Slide Joint
31 Front Right Wheel
32 Front Left Wheel
33 Rear Right Wheel
34 Rear Left Wheel
35 Front Right Upper Joint
36 Front Left Upper Joint
37 Rear Right Upper Joint
38 Rear Left Upper Joint
39 Caster
40 Lower Joints
41 Front Right Lower Joint
42 Front Left Lower Joint
43 Rear Right Lower Joint
44 Rear Left Lower Joint
45 Front Right Base Member
46 Front Left Base Member
47 Rear Right Base Member
48 Rear Left Base Member
49 Base Plate
50 Handle
51 Handle Shaft
52 Handle Bracket Joint
53 Right Handle Member
54 Left Handle Member
55 Handle Grip
56 Front Left Scissor Panel
57 Front Right Scissor Panel
58 Rear Left
59 Rear Right Scissor Panel
60 Left Side Panel
61 Left Side Front Main Member
62 Left Side Front Secondary Member
63 Left Side Front Auxiliary Member
64 Left Side Rear Main Member
65 Left Side Rear Secondary Member
66 Left Side Rear Auxiliary Member
67 Left Middle Post Upper Joint
68 Left Middle Post Lower Joint
69 Left Front Auxiliary Joint
70 Right Side Panel
71 Right Side Front Main Member
72 Left Side Front Secondary Member
73 Right Side Front Auxiliary Member
74 Right Side Rear Main Member
75 Right Side Rear Secondary Member
76 Right Side Rear Auxiliary Member
77 Right Middle Post Upper Joint
78 Right Middle Post Lower Joint
79 Right Front Auxiliary Joint
81 Left Rear Auxiliary Joint
85 Front Right Middle Base Member
86 Front Left Middle Base Member
87 Rear Right Middle Base Member
88 Rear The Middle Base Member
91 Right Rear Auxiliary Joint
94 Left Base Joint
95 Front Base Joint
92 Rear Base Joint
93 Right Base Joint
94 Left Base Joint
100 Wagon Frame
101 Front Right Plate Joint
102 Front Left Plate Joint
103 Rear Right Plate Joint
104 Rear Left Plate Joint

### DETAILED DESCRIPTION OF THE PREFERRED EMBODIMENT

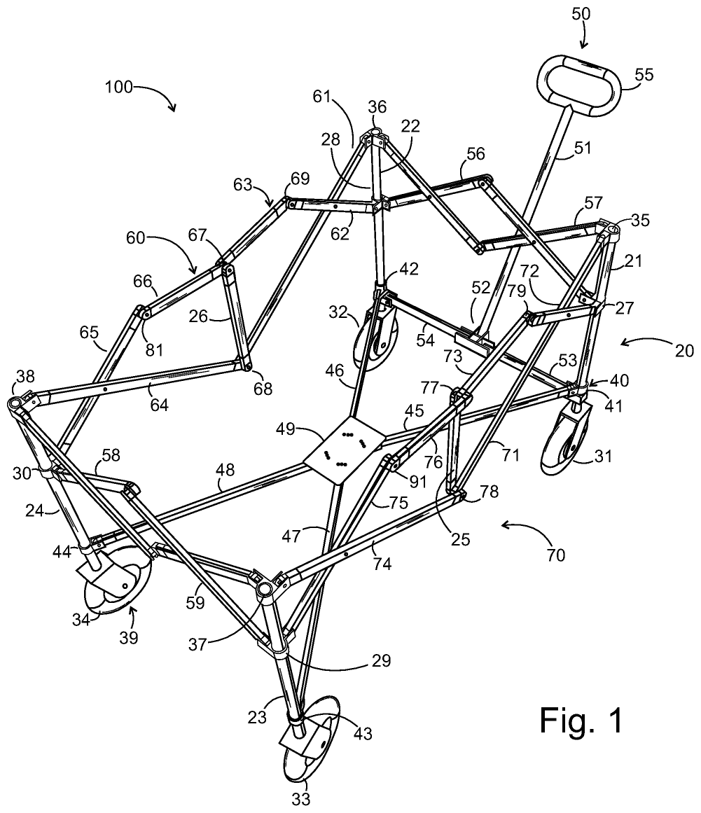

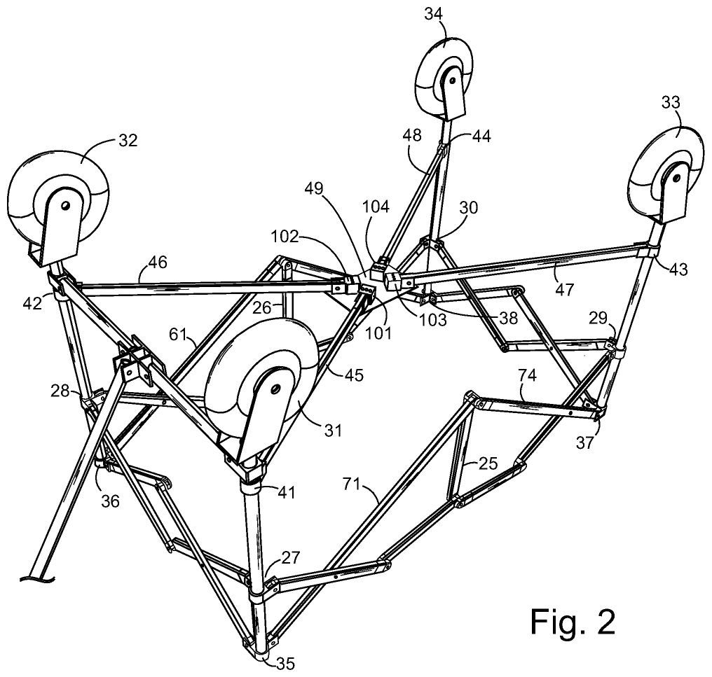

As seen in FIGS. 1-2, the wagon frame 100 has a total of six vertical posts 20 including four in each corner and a pair of middle floating posts. The pair of middle floating posts are not supported at a lower end by abutment to a connection to a lower portion of a corner post. A front right post 21, a front left post 22, a rear right post 23, and the rear left post 24 define the corners of the wagon. The right middle post 25 and the left middle post 26 are formed between the front posts and the rear posts. The six posts are vertically oriented and can be made of tubular steel or aluminum sections that are hinged to other members such as by pivot hinges, or brackets with pivot hinges. The six posts are parallel to each other.

The right middle post 25 is mounted between the front right post 21 and the rear right post 23. The left middle post 26 is mounted between the front left post 22 and the rear left post 24.

Each of the corner posts has a slide joint connected to it for receiving a lower portion of a scissor link panel. The upper scissor link leg is connected to a fixed upper joint while the lower scissor link leg is connected to the slide joint. The slide joint slides up and down from a wagon deployed position to a wagon stowed position. The front right post 21 has a front right slide joint 27, and the front left post 22 has a front left slide joint 28. The rear right post 23 has a rear right slide joint 29, and the rear left post 24 has a rear left slide joint 30. Each of the slide joints can be made of plastic and have a pair of pivot hinges that hinge at a right angle to their respective scissor link panels.

Each corner post is connected to an upper joint. The front right post 21 has a front right upper joint 35, and the front left post 22 has a front left upper joint 36. The rear right post 23 has a rear right upper joint 37, and the rear left post 24 has a rear left upper joint 38. The corner posts are preferably tubular and aligned to allow the slide joint to slide between the upper joint and the lower joint.

The base of the wagon has a base plate 49. The base plate 29 is supported by a front right base member 45, a front left base member 46, a rear right base member 47, and a rear left base member 48. The front right base member 45 connects to the front right lower joint 41 on the front right post 21. The front left base member 46 connects to the front left lower joint 42 on the front left post 22. The rear right base member 47 connects to the rear right lower joint 43 on the rear right post 23. The rear left base member 48 connects to the rear left lower joint 44 on the rear left post 24. The base members swivel on the lower joints from a horizontal deployed position to a vertical stowed position. The base plate 49 remains horizontal in the stowed position and deployed position.

Each of the corner posts is connected to a caster 39 and each caster has a wheel. The front right caster has a front right wheel 31, the front left caster has a front left wheel 32, the rear right caster has a rear right wheel 33, and the rear left caster has a rear left wheel 34.

The wagon has a handle 50 with a handle shaft 51 and a handle grip 55 extending from the handle shaft 51. The handle shaft 51 is pivotally mounted at a handle bracket joint 52. The handle bracket joint 52 pivotally connects the handle shaft 51 to the right handle member 53 and the left handle member 54. The right handle member 53 is pivotally connected to the front right lower joint 41, and the left handle member 54 is pivotally connected to the front left lower joint 42.

The front left post 22 is connected to the front right post 21 by a pair of scissor panels which include a front left scissor panel 56 and a front right scissor panel 57. The front left scissor panel 56 is pivotally connected to the front right scissor panel 57. The front right scissor panel 57 is pivotally connected to the front right upper joint 35 and the front right slide joint 27. The front left scissor panel 56 is pivotally connected to the front left slide joint 28 and the front left upper joint 36. Similarly, the rear left scissor panel 58 and the rear right scissor panel 59 connect the rear left post 24 to the rear right post 23. The rear left scissor panel 58 is connected to the rear right scissor panel 59. The rear left scissor panel 58 is pivotally connected to a rear left upper joint 38 and a rear left slide joint 30. The rear right scissor panel is connected to the rear left scissor panel at a mid line of the wagon frame, but is connected to the rear right upper joint 37 and the rear right slide joint 29 at the rear right post 23.

The vertical posts 20 support a pair of side panels including a left side panel 60 and a right side panel 70. The left side panel 60 has a left side front main member 61 that extends from the front left upper joint 36 to the left middle post lower joint 68. The left middle post lower joint 68 is a lower joint formed on the left middle post 26. The left middle post 26 has an upper joint at the left middle post upper joint 67. The left side front secondary member 62 is pivotally connected to the front left slide joint 28 and the left front auxiliary joint 69. The left front auxiliary joint 69 pivotally connects the left side front secondary member 62 to the left side front auxiliary member 63. The left side front auxiliary member 63 is pivotally connected to the left middle post upper joint 67.

The rear portion of the left side panel 60 is similar to the front portion of the left side panel 60. The left side rear main member 64 is pivotally connected between the left middle post lower joint 68 on the left middle post 26 and the rear left upper joint 38 on the rear left post 24. The left side rear secondary member 65 is pivotally connected to the rear left slide joint 30 and the left rear auxiliary joint 81. The left side rear secondary member 65 is pivotally connected to the left side rear auxiliary member 66 at the left rear auxiliary joint 81.

The right side panel 70 is symmetrical to the left side panel 60. The right side panel 70 has a right side front main member 71 that extends from the front right upper joint 35 to the right middle post lower joint 78. The right middle post lower joint 78 is a lower joint formed on the right middle post 25. The right middle post 25 has an upper joint at the right middle post upper joint 77. The right side front secondary member 72 is pivotally connected to the front right slide joint 27 and the right front auxiliary joint 79. The right front auxiliary joint 79 pivotally connects the right side front secondary member 72 to the right side front auxiliary member 73. The right side front auxiliary member 73 is pivotally connected to the right middle post upper joint 77.

The rear portion of the right side panel 70 is similar to the front portion of the right side panel 70. The right side rear main member 74 is pivotally connected between the right middle post lower joint 78 on the right middle post 26 and the rear right upper joint 37 on the rear right post 23. The right side rear secondary member 75 is pivotally connected to the rear right slide joint 29 and the right rear auxiliary joint 91. The right side rear secondary member 75 is pivotally connected to the right side rear auxiliary member 76 at the right rear auxiliary joint 91.

As seen in FIG. 2, the base plate 49 has an underside that has plate joints which are swivel connections for mounting the base members. The base members have a horizontal portion that abuts the base plate 49 so as to limit the angle of the members to a horizontal deployed position. The abutment of the horizontal portion to the base plate provides a stable base. The plate joints include the front right plate joint 101 that hinges to the front right base member 45. The front left plate joint 102 makes a pivotal connection to the front left base member 46. The rear right plate joint 103 makes a pivotal connection to the rear right base member 47. The rear left plate joint 104 makes a pivotal connection to the rear left base member 48.

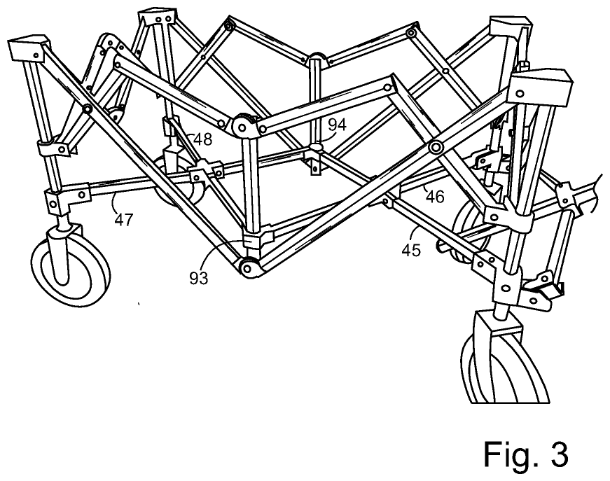

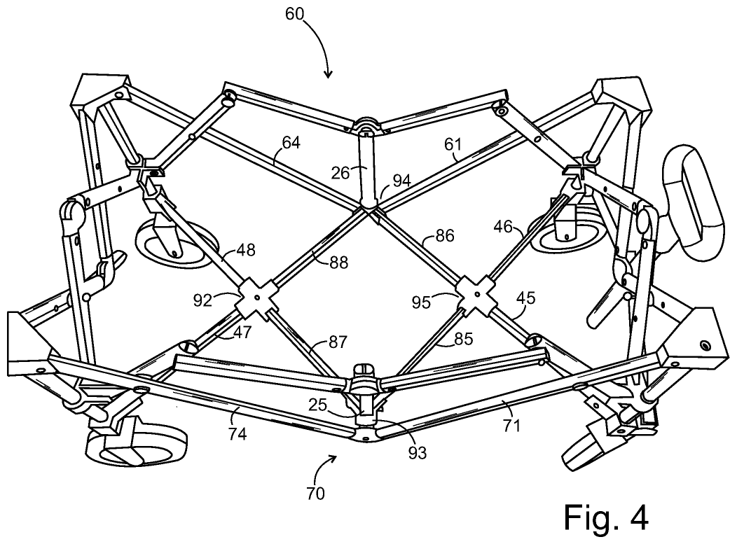

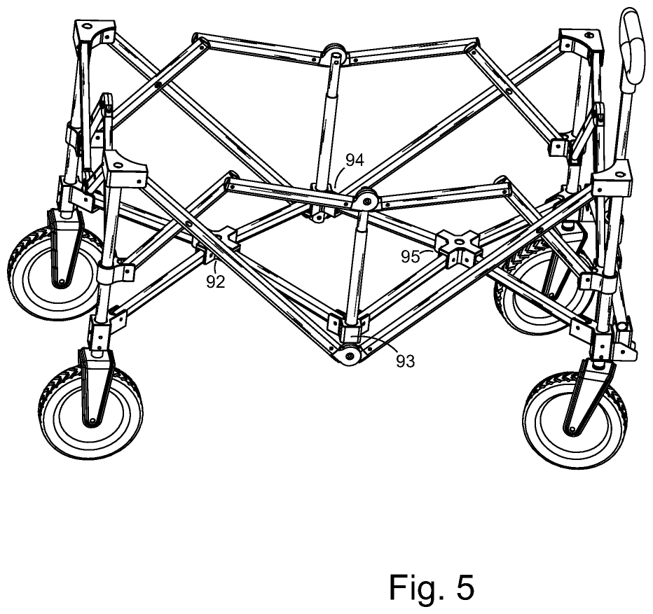

As seen in FIGS. 3-5, in an improved version, a single base plate 49 has been replaced by a front base joint 95 and a rear base joint 92, along with a right base joint 93 and a left base joint 94. A front right middle base member 85 connects to and is hinged to the right base joint 93 and the front base joint 95. Similarly, a front left middle base member 86 is connected to and hinged to the front base joint 95 and the left base joint 94. A rear right middle base member 87 is connected to and hinged to the rear base joint 92 and the right base joint 93. Also, a rear middle base member 88 connects to and is hinged to the rear base joint 92 and the left base joint 94. The right base joint 93 is mounted on the right middle post 25 to slide up and down with the opening and closing of the wagon frame, and the left base joint 94 is mounted on the left middle post 26 to slide up and down with the opening and closing of the wagon frame.

The left side front main member 61 and the left side rear main member 64 are hinged below the left base joint 94. Similarly, the right side front main member and the right side rear main member are hinged below the right base joint.

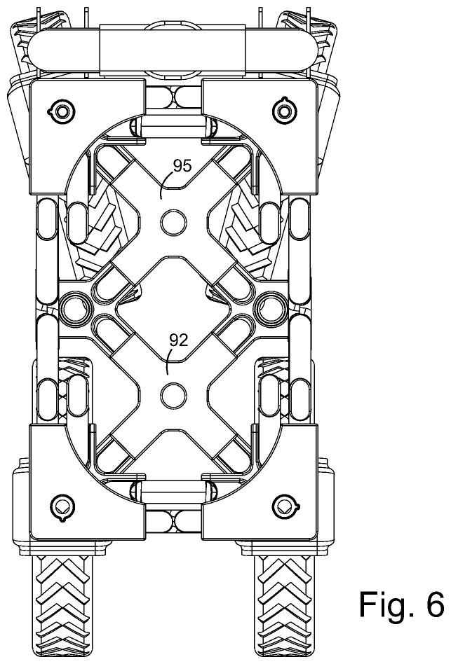

As seen in FIG. 6, the front base joint 95 and the rear base joint 92 may come together to abut each other when the wagon is folded.

1. A folding wagon frame comprising:
corner posts including a front right post, a front left post, a rear right post, and a rear left post;
upper corner joints including a front right upper joint on the front right post, a front left upper joint on the front left post, a rear right upper joint on the rear right post, and a rear left upper joint on the rear left post;
slide joints slidingly mounted below the upper corner joints on the corner posts, including a front right slide joint on the front right post, a front left slide joint on the front left post, a rear right slide joint on the rear right post, and a rear left slide joint on the rear left post;
lower joints mounted to the corner posts below the slide joints, including a front right lower joint on the front right post, a front left lower joint on the front left post, a rear right lower joint on the rear right post, and a rear left lower joint on the rear left post;
middle posts including a left middle post and a right middle post, wherein the middle posts are floating, wherein the right middle post is mounted between the front right post and the rear right post, wherein the left middle post is mounted between the front left post and the rear left post, wherein the right middle post has a right middle post upper joint formed at an upper end of the right middle post, and a right middle post lower joint formed at a lower end of the right middle post, wherein the left middle post has a left middle post upper joint formed at an upper end of the left middle post, and a left middle post lower joint formed at a lower end of the left middle post;
a pair of side panels including a left side panel and a right side panel, wherein the left side panel has a left side front main member that extends from the front left upper joint to the left middle post lower joint, wherein the left side panel has a left side front secondary member pivotally connected to the front left slide joint and a left front auxiliary joint, wherein the left front auxiliary joint pivotally connects the left side front secondary member to a left side front auxiliary member, wherein the left side front auxiliary member is pivotally connected to the left middle post upper joint,
wherein the left side panel has a left side rear main member pivotally connected between the left middle post lower joint and the rear left upper joint, wherein a left side rear secondary member is pivotally connected to the rear left slide joint and to a left rear auxiliary joint, wherein the left side rear secondary member is pivotally connected to a left side rear auxiliary member at a left rear auxiliary joint;
wherein the right side panel has a right side front main member that extends from the front right upper joint to the right middle post lower joint, wherein the right side panel has a right side front secondary member pivotally connected to the front right slide joint and a right front auxiliary joint, wherein the right front auxiliary joint pivotally connects the right side front secondary member to a right side front auxiliary member, wherein the right side front auxiliary member is pivotally connected to the right middle post upper joint;
wherein the right side panel has a right side rear main member pivotally connected between the right middle post lower joint and the rear right upper joint, wherein a right side rear secondary member is pivotally connected to the rear right slide joint and to a right rear auxiliary joint, wherein the right side rear secondary member is pivotally connected to a right side rear auxiliary member at a right rear auxiliary joint, wherein the folding wagon frame has a folded position and a deployed position.

2. The folding wagon frame of claim 1, further comprising: a pair of front scissor panels, including a front left scissor panel and a front right scissor panel connected to each other, wherein the pair of front scissor panels connects between the front right post and the front left post, wherein the front right scissor panel connects to the front right upper joint and the front right slide joint, and wherein the front left scissor panel connects to the front left upper joint and the front left slide joint.

3. The folding wagon frame of claim 2, further comprising: a pair of rear scissor panels, including a rear left scissor panel and a rear right scissor panel connected to each other, wherein the pair of rear scissor panels connects between the rear right post and the rear left post, wherein the rear right scissor panel connects to the rear right upper joint and the rear right slide joint, and wherein the rear left scissor panel connects to the rear left upper joint and the rear left slide joint.

4. The folding wagon frame of claim 3, further comprising:
a front right middle base member that connects to and is hinged to a right base joint and a front base joint;
a front left middle base member that connects to and is hinged to the front base joint and a left base joint;
a rear right middle base member that connects to and is hinged to a rear base joint and the right base joint; and
a rear middle base member that connects to and is hinged to the rear base joint and the left base joint, wherein the right base joint is mounted on the right middle post to slide up and down with the opening and closing of the wagon frame, and the left base joint is mounted on the left middle post to slide up and down with the opening and closing of the wagon frame.

5. The folding wagon frame of claim 4, further comprising: a handle having a handle grip and handle shaft, wherein the handle shaft is pivotally connected to a handle bracket joint, and further including a right handle member and a left handle member, wherein the right handle member is pivotally connected to the handle bracket joint and the front right lower joint, and wherein the left handle member is pivotally connected to the handle bracket joint and the front left lower joint, wherein the right handle member and the left handle member fold between a deployed horizontal configuration and a stowed vertical configuration.

6. The folding wagon frame of claim 1, further comprising: a pair of rear scissor panels, including a rear left scissor panel and a rear right scissor panel connected to each other, wherein the pair of rear scissor panels connects between the rear right post and the rear left post, wherein the rear right scissor panel connects to the rear right upper joint and the rear right slide joint, and wherein the rear left scissor panel connects to the rear left upper joint and the rear left slide joint.

7. The folding wagon frame of claim 1, further comprising: a front right middle base member that connects to and is hinged to a right base joint and a front base joint;
a front left middle base member that connects to and is hinged to the front base joint and a left base joint;
a rear right middle base member that connects to and is hinged to a rear base joint and the right base joint; and
a rear middle base member that connects to and is hinged to the rear base joint and the left base joint, wherein the right base joint is mounted on the right middle post to slide up and down with the opening and closing of the wagon frame, and the left base joint is mounted on the left middle post to slide up and down with the opening and closing of the wagon frame.

8. The folding wagon frame of claim 1, further comprising: a handle having a handle grip and handle shaft, wherein the handle shaft is pivotally connected to a handle bracket joint, and further including a right handle member and a left handle member, wherein the right handle member is pivotally connected to the handle bracket joint and the front right lower joint, and wherein the left handle member is pivotally connected to the handle bracket joint and the front left lower joint, wherein the right handle member and the left handle member fold between a deployed horizontal configuration and a stowed vertical configuration.

9. The folding wagon frame of claim 8, further comprising: a pair of rear scissor panels, including a rear left scissor panel and a rear right scissor panel connected to each other, wherein the pair of rear scissor panels connects between the rear right post and the rear left post, wherein the rear right scissor panel connects to the rear right upper joint and the rear right slide joint, and wherein the rear left scissor panel connects to the rear left upper joint and the rear left slide joint.

10. The folding wagon frame of claim 8, further comprising: a front right middle base member that connects to and is hinged to a right base joint and a front base joint;
a front left middle base member that connects to and is hinged to the front base joint and a left base joint;
a rear right middle base member that connects to and is hinged to a rear base joint and the right base joint; and
a rear middle base member that connects to and is hinged to the rear base joint and the left base joint, wherein the right base joint is mounted on the right middle post to slide up and down with the opening and closing of the wagon frame, and the left base joint is mounted on the left middle post to slide up and down with the opening and closing of the wagon frame.
